(19) United States
(12) Patent Application Publication
(10) Pub. No.: US 2007/0029020 A1
(43) Pub. Date: Feb. 8, 2007

(54) Solid suspended tire

(75) Inventors: Ross P. Wietharn, Peoria, IL (US); Sunil I. Mathew, Peoria, IL (US); Brook A. Plavec, Peoria, IL (US); Dan J. Becker, Peoria, IL (US); David W. McKeever, Hanna City, IL (US)

Correspondence Address: CATERPILLAR INC.;100 N.E. ADAMS STREET, PATENT DEPT., PEORIA, IL, 616296490, US

(73) Assignee: Caterpillar Inc.

(21) Appl. No.: 11/544,784

(22) Filed: Oct. 6, 2006

Related U.S. Application Data
(63) Continuation-in-part of application No. 10/864,898, filed on Jun. 9, 2004.
(63) Continuation-in-part of application No. 29/238,609, filed on Sep. 16, 2005.

(51) Int. Cl. B60C 7/00

(52) U.S. Cl. 152/324

(57) ABSTRACT

A tire includes an annular body of elastomeric material that includes a middle radial region. A plurality of unpressurized cavities are defined by the middle radial region and are distributed in a pattern that includes a first radial band of cavities and a second radial band of cavities. Each cavity of the first radial band of cavities is oriented at a positive angle with respect to a radius therethrough, and each cavity of the second radial band of cavities is oriented at a negative angle with respect to a radius therethrough.

### RELATION TO OTHER PATENT

This application is a continuation-in-part of patent application Ser. No. 10/864,898, filed on Jun. 9, 2004 and a continuation-in-part of patent application Ser. No. 29/238609, filed on Sep. 16, 2605.

### TECHNICAL FIELD

The present disclosure relates generally to tires, and more specifically to non-pneumatic tires.

### BACKGROUND

Because machines often operate in harsh environments and are continuously cycling through no load and relatively heavy loads, tires must be durable and not susceptible to flats. In fact, it has been found that although conventional pneumatic tires provide a smooth ride, pneumatic tires often are less durable than solid tires. However solid tires are known to provide a less than smooth ride.

In order to provide sufficient durability, tires can be non-pneumatic, and thus, are comprised of solid or semi-solid products. Although the non-pneumatic tires are more durable than pneumatic tires, the non-pneumatic tires are often too stiff to provide a smooth ride and lack the contact area with the ground to provide relatively good traction. In order to improve the ride of the machine, some non-pneumatic tires include a radial band of unpressurized cavities, or recesses. The radial band lessens the stiffness and increases the deformation of the tire so it will ride better than a solid tire. Such a tire is sold by MITL under a trademark that suggests flexibility, but it still provides a stiff ride more similar to a solid tire than a pneumatic tire.

In another example, the non-pneumatic tire described in U.S. Pat. No. 5,042,544, issued to Dehasse, on Aug. 27, 1991, define a radial band of recesses that enable the tire to deform due to a load and provides an area of contact with the road that is supposedly similar to that provided by a pneumatic tire. Further, in order to better control the deformability of the tire and to limit the collapse of the recesses, the recesses of the Dehasse non-pneumatic tire are taught as being intrinsically dissymmetrical to any radial direction and overlap one another. Although the Dehasse non-pneumatic tire uses recesses in order to control the tire performance and road handling, the Dehasse tire is intended to have a weight and bulk similar to that of pneumatic tires. Thus, the Dehasse tire would not possess the durability required for high load, low speed machine applications.

Tires are also subjected to tangential forces, such as braking and traction forces, and widely varying radial forces associated with payload. A single radial band of cavities, especially those that are angled, would exhibit unequal clockwise and counterclockwise torsional stiffness. In addition, they would have the tendency to rotate the outer portion of the tire relative to the hub as radial load is varied. This torsional stiffness bias could result in undesirable and unpredictable machine motion.

The present disclosure is directed at overcoming one or more of the problems set forth above.

SUMMARY OF THE DISCLOSURE

In one aspect, a tire includes an annular body of elastomeric material. A radial middle region of the elastomeric material defines a plurality of unpressurized cavities distributed in a pattern that includes a first radial band of cavities and a second radial band of cavities. Each cavity of the first radial band of cavities is oriented at a positive angle with respect to a radius line extending from a tire axis of rotation through the respective cavity, and each cavity of the second radial band of cavities is oriented at a negative angle with respect to a radius line extending from a tire axis of rotation through the respective cavity. In one aspect, a material volume of the radial middle region is about 1.4 times greater than said combined void volume of the plurality of unpressurized cavities.

In another aspect, each of the cavities is defined by first and second arches connected by first and second deflectable wall portions. In another aspect, a length of each of the plurality of unpressurized cavities is less than approximately one and a half times a width of each of the plurality of unpressurized cavities

### BRIEF DESCRIPTION OF THE DRAWINGS

FIG. 1 is an isometric view of a tire, according to a first embodiment of the present disclosure;

FIG. 1a is a cross-sectioned view of a radial outer or tread region of the tire of FIG. 1;

FIG. 1b is an isometric view of a radial middle region of the tire of FIG. 1;

FIG. 2 is an isometric view of a tire, according to a second embodiment of the disclosure;

FIG. 2a is a cross-sectioned view of a radial outer or tread region of the tire of FIG. 2;

FIG. 3 is an isometric view of a tire, according to a third embodiment of the disclosure;

FIG. 3a is a cross-sectioned view of a radial outer or tread region of the tire of FIG. 3;

FIG. 4 is an isometric view of a tire, according to a fourth embodiment of the disclosure;

FIG. 5 is a partial cross-sectioned isometric view of a tire, according to a fifth embodiment of the disclosure;

FIG. 5a is a diagrammatic representation of a portion of the tire having an alternate embodiment of the cavities of FIG. 5;

FIG. 6 is an isometric view of a tire according to a sixth embodiment of the disclosure;

FIG. 6a is a cross sectional view of a radial outer or tread region of the tire of FIG. 6;

FIG. 7 is an isometric view of a tire according to a seventh embodiment of the disclosure;

FIG. 7a is a cross sectional view of a radial outer or tread region of the tire of FIG. 7;

FIG. 8 is an isometric view of a tire according to an eighth embodiment of the disclosure;

FIG. 8a is a cross sectional view of a radial outer or tread region of the tire of FIG. 8;

FIG. 9 is a collection of diagrammatic representations of various-shaped cavities for tires, according to the disclosure;

FIG. 10 is a diagrammatic representation illustrating deflection of a tire under a radial load, according to a first embodiment of the disclosure;

FIG. 11 is a diagrammatic representation illustrating deflection of a tire under a radial load, according to a seventh embodiment of the disclosure;

and

FIG. 12 is a graph illustrating a tire deflection versus radial load according to the disclosure, for comparison with solid and pneumatic tires.

### DETAILED DESCRIPTION

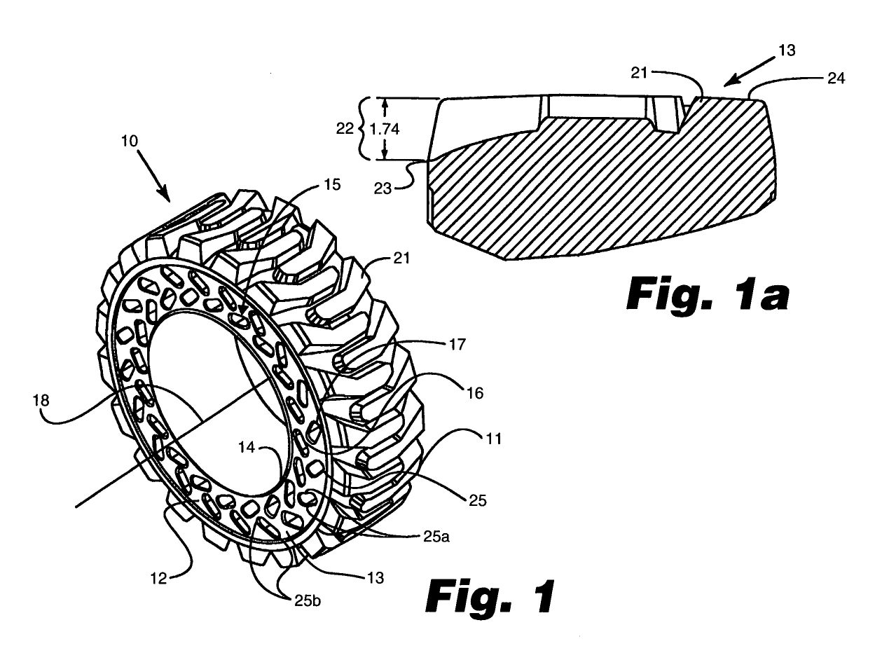

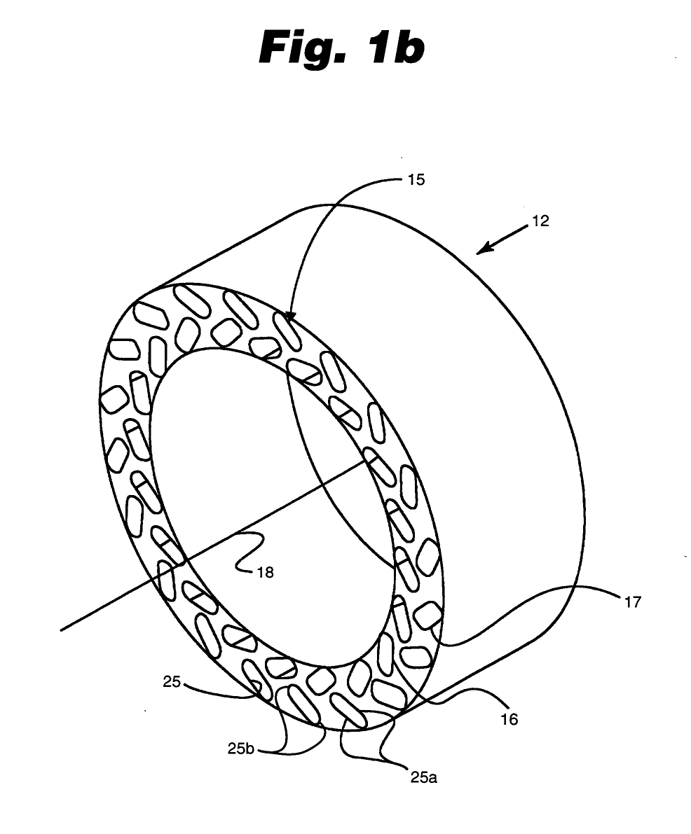

Referring to FIG. 1, there is shown an isometric view of a tire 10, according to a first embodiment of the present disclosure. All tires 10, 110, 210, 310, 410, 510 and 610 illustrated in the first through seventh embodiments are 31 inch diameter tires. The tire 710 illustrated in the eighth embodiment is a 33 inch diameter tire. Those skilled in the art will appreciate that the present disclosure contemplates tires of various sizes that can be used with a variety of machines (not shown), including relatively small machines, such as small wheel loaders, backhoe loaders, trucks, and the like, as well as with other larger machines that may still be suitable. The tire 10 includes an annular body 11 of elastomeric material. Although the annular body 11 could be made from various elastomeric materials, the annular body 11 is illustrated as being made from rubber of any suitable tire formulation known in the art. For example, tire 10 might be molded from a natural rubber or a natural/synthetic rubber blend having a Young's Modulus between 1 MPa and 6 MPa at 100% elongation. For the embodiments shown, a 100% tensile modulus of about 2.75 MPa is used. Fully synthetic elastomers, such as polyurethanes could also be used. The annular body 11 includes a radial middle region 12, a radial outer region 13 and a radial inner region 14, both of which are adjacent to the radial middle region 12. The radial inner region 14 attaches to a wheel hub in a conventional manner, such as by being directly bonded thereto, and the wheel is attached to the machine. The radial outer region includes the tread.

The radial outer region 13 and the radial inner region 14 are preferably, but not necessarily cavity-free, and the radial middle region 12 defines a plurality of unpressurized cavities 15 that are distributed in a pattern that includes a first radial band of cavities 16 and a second radial band of cavities 17. The bands may or may not overlap, depending upon the desired properties of the particular application. As illustrated, the cavities 15 are evenly spaced throughout each radial band 16 and 17. Each cavity within the first radial band of cavities 16 is oriented at a positive angle with respect to a radius therethrough, or a radius line extending from a tire axis of rotation through the respective cavity, and each cavity within the second radial band of cavities 17 is oriented at a negative angle with respect to a radius therethrough. The first and second radial bands of cavities 16 and 17 are oriented at opposing angles in order to cancel or reduce any torsional stiffness bias created by each radial band of cavities 16 and 17. Without the first radial band of cavities 16 canceling the torsional stiffness bias of the second radial band of cavities 17, and vice versa, a tangential force acting in a forward direction on the tire 10, when compared with the reverse direction, might cause a significantly different degree of rotation of an outer portion of the tire 10 to rotate with respect to an inner portion. This could result in unpredictable machine motion during acceleration, stopping, pulling, pushing, digging, or any other work cycle that could produce a tangential force on the tire. In the illustrated first embodiment, the positive angle is 63° and the negative angle is 52° with respect to a radial line through the center of the cavity. However, those skilled in the art appreciate that the positive and negative angles can vary, and are determined based on various factors, including but not limited to, the size and shape of cavities within the first radial band and the second radial band. Moreover, although the positive angle of the first radial band 16 may be different than the negative angle of the second radial band 17, those skilled in the art will appreciate that the positive angle and the negative angle could be the same. However, to do so, the shape and/or size and/or number of the cavities within the first radial band may need to be different than the shape and/or size and/or number of cavities in the second radial band in order to generate similar performance. When scaling, the number of cavities may or may not be proportional to the diameter of the tire.

In the illustrated first embodiment of FIG. 1, the tire 10 includes forty unpressurized cavities 15, with twenty unpressurized cavities within each of the first and second radial bands 16 and 17. Although each of the unpressurized cavities within the plurality 15 is shown to have an axis of symmetry parallel to a tire axis of rotation 18, each of the unpressurized cavities within the plurality 15 may also be skewed with relation to the tire axis of rotation 18. Furthermore, even though the plurality of unpressurized cavities 15 shown in FIG. 1 have a uniform shape and volume, it should be appreciated that the first radial band of cavities 16 could have a different shape than the second radial band of cavities 17. For instance, if the first and second radial bands were oriented at the similar positive and negative angles, the shape and/or size of the first radial band may differ from the shape and/or sizes of the second radial band. Although the present disclosure contemplates various shapes of the cavities, the uniform shape illustrated includes a cross-sectional shape with a perimeter 25 that includes a pair of straight wall portions 25a separated by a pair of arches 25b. The length and width of the cross-sectional shape can vary depending on various factors, including but not limited to, the desired combined void volume. In the first embodiment, the length of the cavities 15 is illustrated as approximately 2.3 inches, the width is approximately 0.9 inch, and the depth is approximately 4.9 inches if extending half the tire width, but may be 9.8 inches if extending the full width of the tire.

Referring to FIG. 1a, there is shown a cross-sectioned view of the radial outer region 13 of the tire 10. The radial outer region 13 includes an exposed off-road tread pattern 21 that has a depth 22, which is the distance between a base 23 and a top 24 of the tread 21. The view of FIG. 1a and similar views in the other drawings show the theoretical intersection of the side profile and the crown at the corners; it may not reflect the maximum diametrical location on the tire. Although maximum tread depth is desirable for traction and wear purposes, the tread depth 22 is limited by the overall desired diameter of the tire 10. Those skilled in the art will appreciate that the larger the material volume between the outer radial band of cavities, illustrated in FIG. 1 as the second radial band of cavities 17, and the outer diameter of the tire, the greater the possible tread depth 22. Thus, in order to maintain the diameter of a tire while increasing the tread depth, the pattern of cavities can be made more compact or the number of cavities limited, which, in return, could affect the desired stiffness and rubber strain of the tire under a load. Therefore, the tread depth 22 is typically a compromise between the desired traction, stiffness and rubber strain of the tire 10. In the first embodiment illustrated in FIG. 1a, the off-road tread is 1.74 inches deep. Those skilled in the art will appreciate that the off-road tread 21 should be sufficient for the operation of tire 10 in the selected environment.

Referring to FIG. 1b, there is shown an isometric view of the radial middle region 12 of the tire 10. The radial middle region 12 includes a material volume, and the plurality of unpressurized cavities 15 has a combined void volume. For purposes of this disclosure, radial middle region 12 is bounded by an inner diameter that is tangent to the inner band of cavities 16, and bounded by an outer diameter tangent to the outer band of cavities 17. In the first embodiment of the tire, the material volume of the radial middle region 12 is about twice the combined void volume of the un-pressurized cavities. However, the ratio of material volume to void material volume may greatly vary from about 1.5 times or less to about 2.5 times or more. Those skilled in the art will appreciate that the cavities 15 within the tire 10 lessen the stiffness of the tire 10 in order to provide deflection and a relatively smooth ride for the operator, the load and the machine. Moreover, the cavities 15 permit the material to deflect by bending, rather than by either pure compression or stretching, thereby limiting the material strain while permitting substantial deflections. However, the tire 10 must include sufficient material in order to carry the loads to which the machine is subjected. Thus, the determination of the material volume to the combined void volume ratio is a compromise between various known factors, including but not limited to the desired stiffness and strain and durability of the tire.

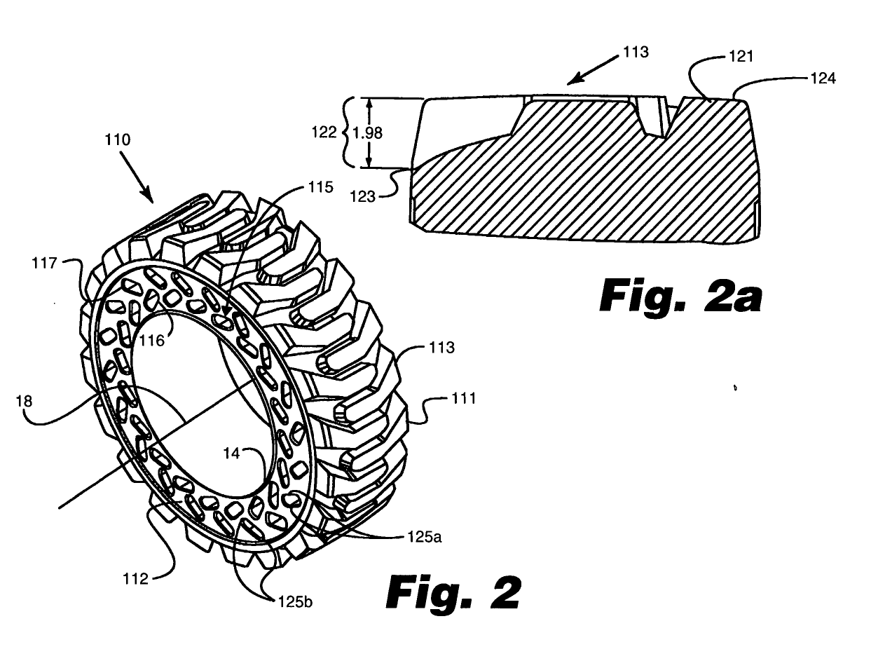

Referring to FIG. 2, there is shown an isometric view of a tire 110, according to a second embodiment of the present disclosure. The tire 110 includes an annular body 111 that includes a radial middle region 112 adjacent to a preferably cavity-free radial inner region 114 and a preferably cavity-free radial outer region 113. The tire 110 of the second embodiment is similar to the tire 10 of the first embodiment except the material volume to the combined void volume ratio of the tire 110 is greater than that of the first embodiment. The material volume of the radial middle region 112 is 2.1 times greater (which is still about twice) than the combined void volume of the plurality of unpressurized cavities 115. Being that both tires 10 and 110 include twenty cavities in each of their respective first and second radial bands 16, 116 and 17, 117, the material volume to combined void volume ratio is greater because the size of each cavity within the plurality 115 is smaller. In the illustrated second embodiment, each cavity within the plurality 115 includes a length of 2.2 inches, a width of 0.9 inch, and a depth of 4.9 inches for halfway through (9.8 inches if full width of tire).

Referring to FIG. 2a, there is shown a cross-sectioned view of a radial outer region 113 of the tire 110 of FIG. 2. Similar to the first embodiment, the radial outer region 113 includes an exposed off-road tread pattern 121 that has a depth 122 defined as the distance between a base 123 of the tread 121 and a top 124 of the tread 121. Whereas the depth 22 of the off-road tread pattern 21 of FIG. 1 was 1.74 inches, the depth 122 of the off-road tread pattern 121 of the second embodiment is 1.98 inches. Being that the second embodiment includes a greater material volume to void volume ratio, the tire 110 can support a thicker off-road tread 121 than in the first embodiment. However, the higher material volume to void volume ratio may result in an increased stiffness that can affect the smoothness of the machine ride.

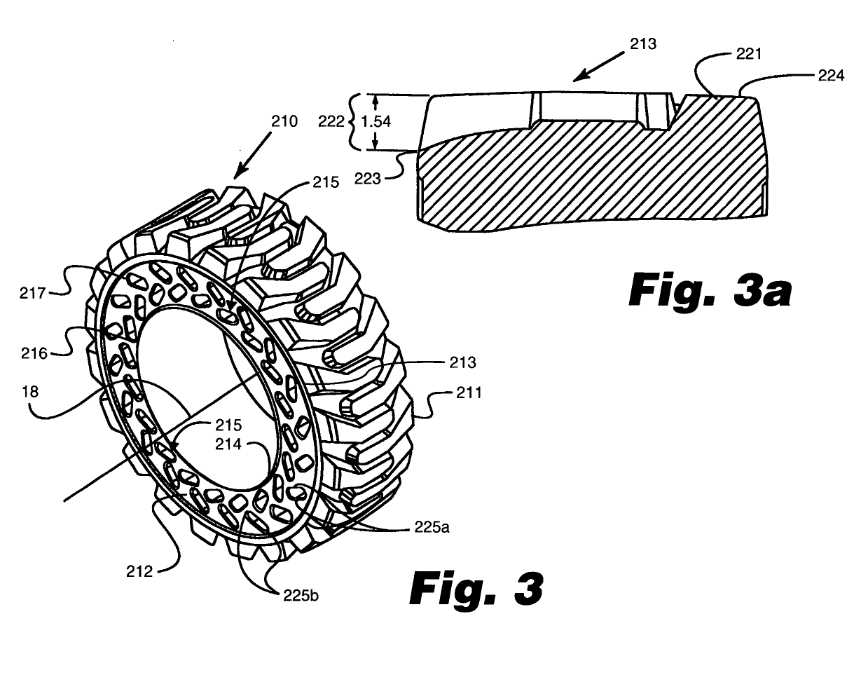

Referring to FIG. 3, there is shown a tire 210, according to a third embodiment of the present disclosure. The tire 210 includes an annular body 211 that includes a radial middle region 212 adjacent to a preferably cavity-free radial inner region 214 and a preferably cavity-free radial outer region 213. The tire 210 is similar to the tires 10 and 110 of the first and second embodiments except that a material volume to a combined void volume ratio of the tire 210 is less than that of the first and the second embodiments. The radial middle region 212 of the tire 210 includes the material volume that is 1.8 times greater (which is still about twice) than the combined void volume of the plurality of cavities 215. Each cavity within the plurality 215 includes a length of 2.3 inches, a width of 1.1 inches, and a depth of 4.9 inches for half way through (9.8 inches if full width of tire).

Referring to FIG. 3a, there is shown a cross-sectioned view of a radial outer region 213 of the tire 210 of FIG. 3. As with the first and second embodiments, the radial outer region 213 includes an exposed off-road tread 221 that includes a depth 222 defined as the distance between a base 223 and a top 224 of the tread 221. The depth 222 of the tread 221 is 1.54 inches. Being that the material volume to combined void volume of the tire 210 is less than that of the first and second embodiments, the tire 210 includes a thinner tread 221, but likely provides a smoother ride.

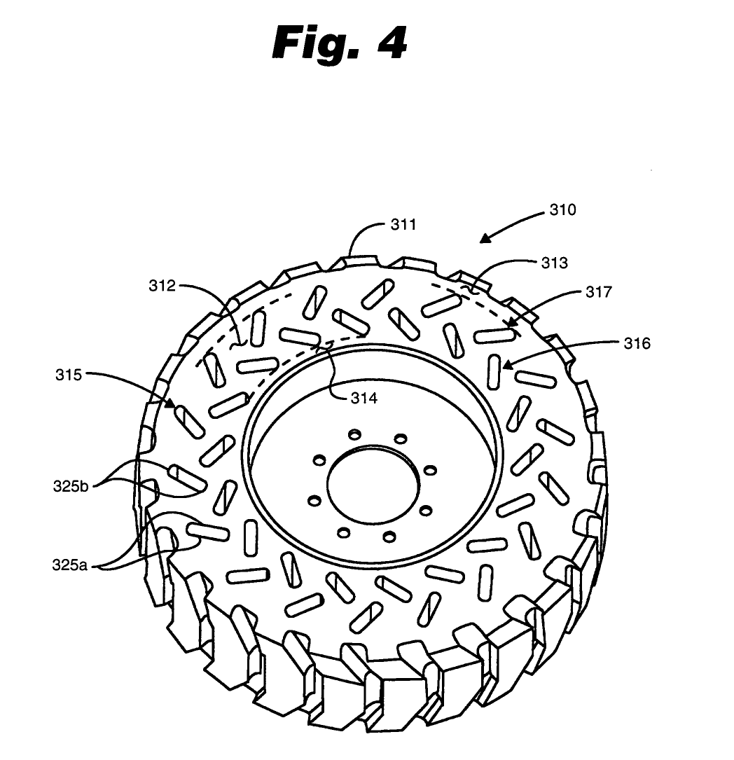

Referring to FIG. 4, there is shown a tire 310, according to a fourth embodiment of the present disclosure. As with the other embodiments, the tire 310 includes an annular body 311 that includes a radial middle region 312 adjacent to a preferably cavity-free radial inner region 314 and a preferably cavity-free radial outer region 313. The radial middle region 312 defines a plurality of unpressurized cavities 315 that include that a first radial band of cavities 316 that are oriented at a positive angle with respect to a radius therethrough and a second radial band of cavities 317 that are oriented at a negative angle with respect to a radius therethrough. Whereas the tires 10, 110 and 210 of the first, second and third embodiments include twenty cavities in each radial band 16, 116, 216 and 17, 117, 217, the tire 310 defines eighteen cavities in each of the first and second radial bands 316 and 317, for a total of thirty-six cavities within the plurality 315. Further, a material volume of the radial middle region 312 is 2.6 times a combined void volume of the plurality of cavities 315.

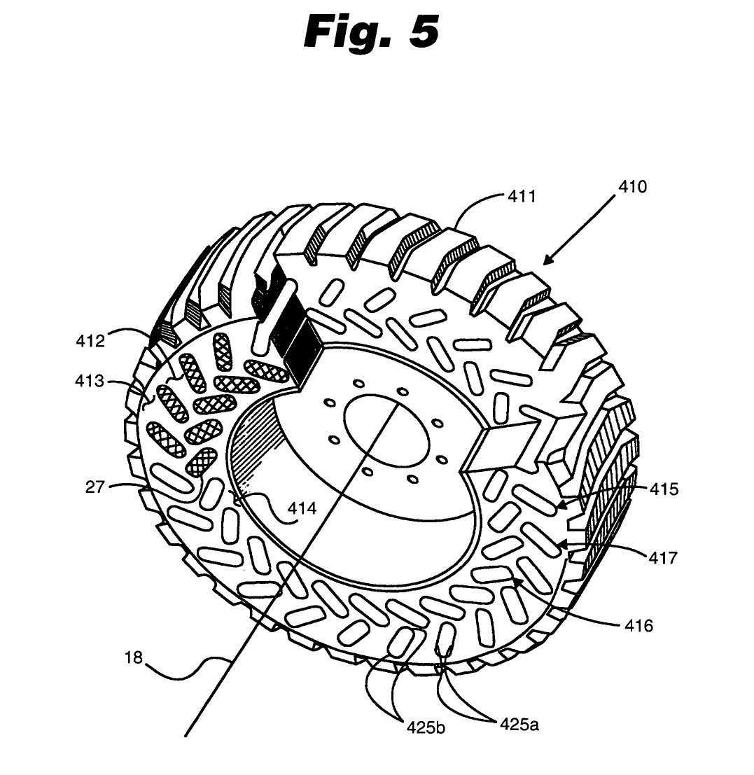

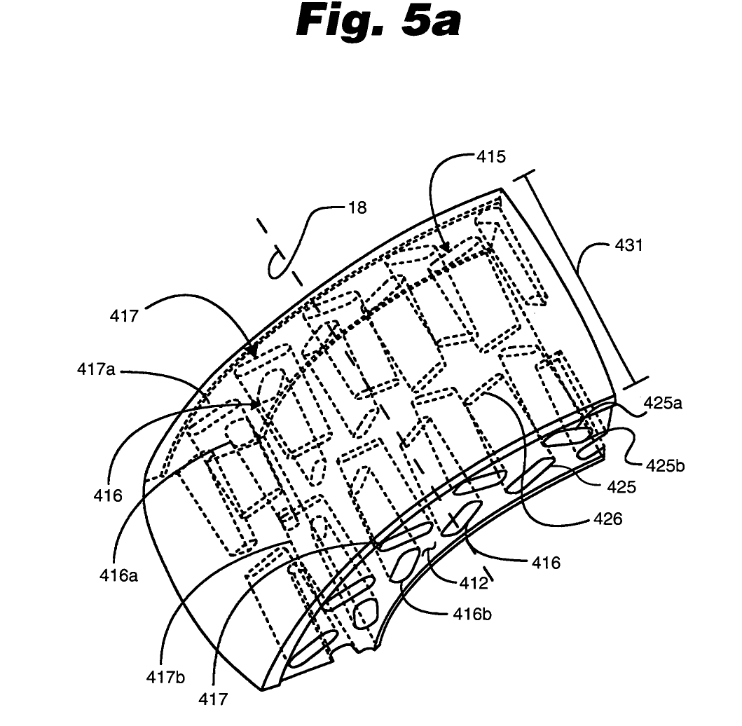

Referring to FIG. 5, there is shown a partial cross-sectioned angled view of a tire 410, according to a fifth embodiment of the present disclosure. The tire 410 includes an annular body 411 that includes a radial middle region 412 adjacent to a preferably cavity-free radial inner region 414 and a preferably cavity-free radial outer region 413. The radial middle region 412 defines a plurality of unpressurized cavities 415 that include that a first radial band of cavities 416 that are oriented at a positive angle with respect to a radius therethrough and a second radial band of cavities 417 that are oriented at a negative angle with respect to a radius therethrough. The tire 410 includes twenty-four cavities in each of the first and second radial bands 416 and 417, for a total of forty-eight cavities 415. Further, a material volume of the radial middle region 412 is 2.1 times a combined void volume of the plurality of cavities 415. The increased number of cavities 415 and their associated size may provide for a soft ride, but the cavities 415 may not be able to handle as much weight before they begin to collapse and the tire 410 begins to responds like a solid tire.

Although any embodiment of the present disclosure could include a barrier 27 for, at least, a portion of the cavities, the tire 410 is illustrated as including at least one barrier 27 separating the unpressurized cavities 415 from the space surrounding the tire 410. As can be seen, the other embodiments show cavities that open through sidewalls of the respective tires. The barriers 27 prevent debris from entering the cavities 415 and affecting the performance of the tire 410. The present disclosure contemplates the barriers 27 being comprised of various materials, including, but not limited to a thin screen or rubber layer over the cavity, or possibly by filling the cavity with an elastomeric foam. Thus, the barriers 27 can be inserted into the cavities 415 or cover the opening of the cavities 415. Those skilled in the art will appreciate that the material for the barriers 27 can be selected to alter the deflection rate of the tire 410, or to not affect the performance of the tire 410.

Alternatively, the deflection rate of the tire 410 may be altered through the use of a sleeve (not shown) that may conform to fit within, at least, a portion of the cavities 415. The present disclosure contemplates the sleeves being comprised of various materials, such as rubber, plastics, metals and the like that may improve the deflection rate of the tire 410. The sleeves may conform to the inner surface of the cavities 415 or may only contact a portion of the inner surface of the cavities 415. Additionally, the sleeves may extend all or part of the way through the width of the tire 410 and may be hollow or solid. Use of a sleeve may become increasingly important over the life of a tire as the deflection rate may decrease over time.

Referring to FIG. 5a, there is shown a diagrammatic representation of a portion of the tire 410 having an alternate embodiment of the cavities 415 of FIG. 5. Although the present disclosure contemplates the unpressurized cavities extending through a width of the radial middle region 412, the unpressurized cavities 415 are illustrated as extending about half the width 431 of the alternate embodiment of tire 410. The first radial band of cavities 416 includes an inboard band of cavities 416a and an outboard band of cavities 416b that are out of phase with respect to the inboard band of cavities 416a about the axis of rotation 18. Similarly, the second radial band of cavities 417 includes an inboard band of cavities 417a and an outboard band of cavities 417b that are out of phase with respect to the inboard band of cavities 417a about the axis of rotation 18. Thus, the cavities 415 are evenly spread throughout the radial middle region 412 in order to provide uniform performance of the tire 410 throughout 360° of rotation. Furthermore, each cavity of the plurality 415 may also include a tapered end 426 as compared to the cavity perimeter 425. The tapered end 426 may be adjacent to the middle of the width 431 of the tire 410. The tapered ends 426 of the cavities 415 eases the removal of a molding core from the elastomeric material to form the cavities 415 during manufacturing. A taper can impart a different spring rate to the tire, and can be used to tailor the ground pressure distribution under the tire, i.e. cause the middle of the tire to carry more load. It is also contemplated that the taper may apply to any one of a number of cavity geometries.

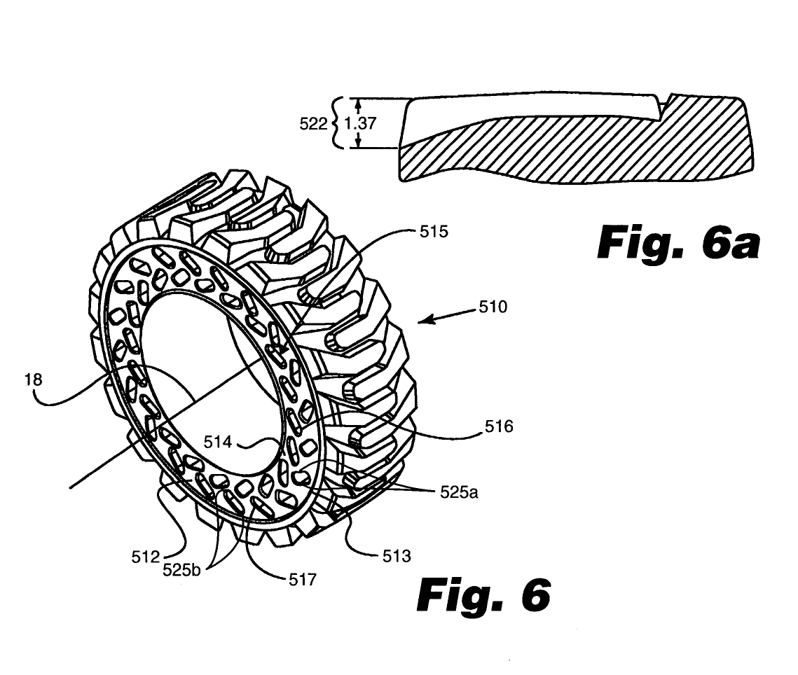

Referring now to FIGS. 6 and 6a, a tire 510 according to still another embodiment of the present disclosure is illustrated. Like the other tires previously described, tire 510 includes a radial inner region 514, a radial middle region 512 that includes a plurality of unpressurized cavities 515 and a radial outer region 513 that includes the tread. In this embodiment, the tread has a depth 522 of about 1.37 inches. This embodiment is similar to some of the previous embodiments in that each of the radial bands of cavities 516 and 517 each include twenty cavities. Also, this embodiment differs from the earlier embodiment in that the ratio of the material volume to the combined void volume in the middle region 512 is 1.6.

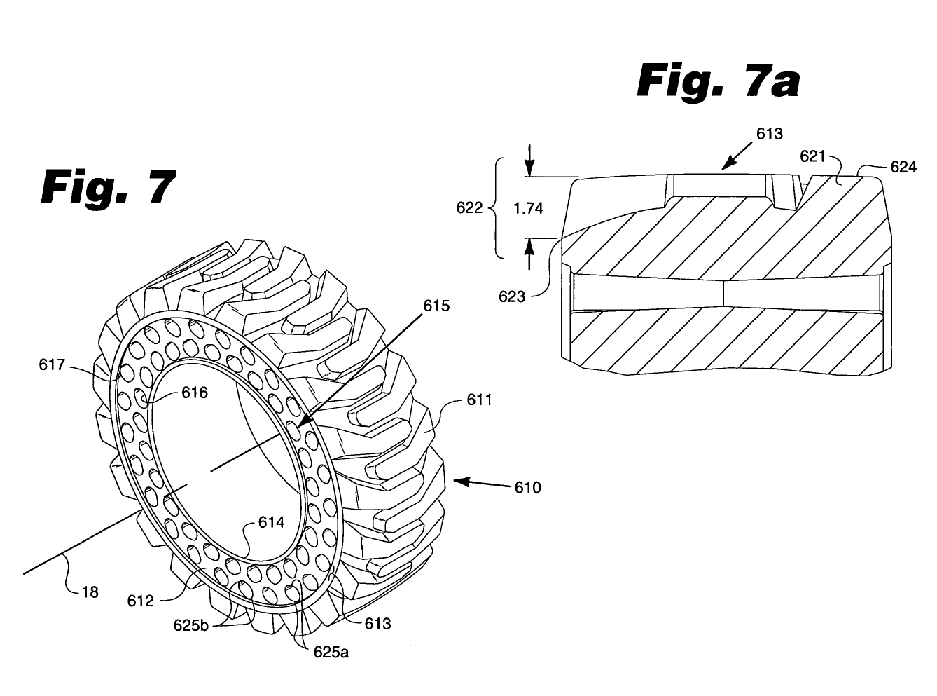

Referring to FIG. 7, there is shown an isometric view of a tire 610, according to a seventh embodiment of the present disclosure. The tire 610 includes an annular body 611 that includes a radial middle region 612 adjacent to a preferably cavity-free radial inner region 614 and a preferably cavity-free radial outer region 613. The material volume of the radial middle region 612 is 1.47 times (which is about 1.5 times) greater than the combined void volume of the plurality of unpressurized cavities 615. The tire 610 includes fifty unpressurized cavities 615, with twenty-five unpressurized cavities within each of the first and second radial bands 616 and 617. Although each of the cavities 615 have different dimensions than the cavities 15 of the first embodiment, the cavities 615 are still oriented at positive and negative angles and they have a pair of straight wall portions 625a separated by a pair of arches 625b. In the illustrated seventh embodiment, each cavity within the plurality of cavities 615 includes a length of 1.7 inches, a width of 1.3 inches, and a depth of 4.75 inches for halfway through (9.5 inches if full width of tire).

Referring to FIG. 7a, there is shown a cross-sectioned view of a radial outer region 613 of the tire 610 of FIG. 7. Similar to the first embodiment, the radial outer region 613 includes an exposed off-road tread pattern 621 that has a depth 622 defined as the distance between a base 623 of the tread 621 and a top 624 of the tread 621. The depth 622 of the off-road tread pattern 621 of the seventh embodiment is 1.74 inches. Since the straight wall portions 625a of the cavities 615 are not as elongated as in the first through sixth embodiments and the width of the cavities 615 are greater, the tire 610 may have less deflection even though the material void volume ratio is less than in the other embodiments.

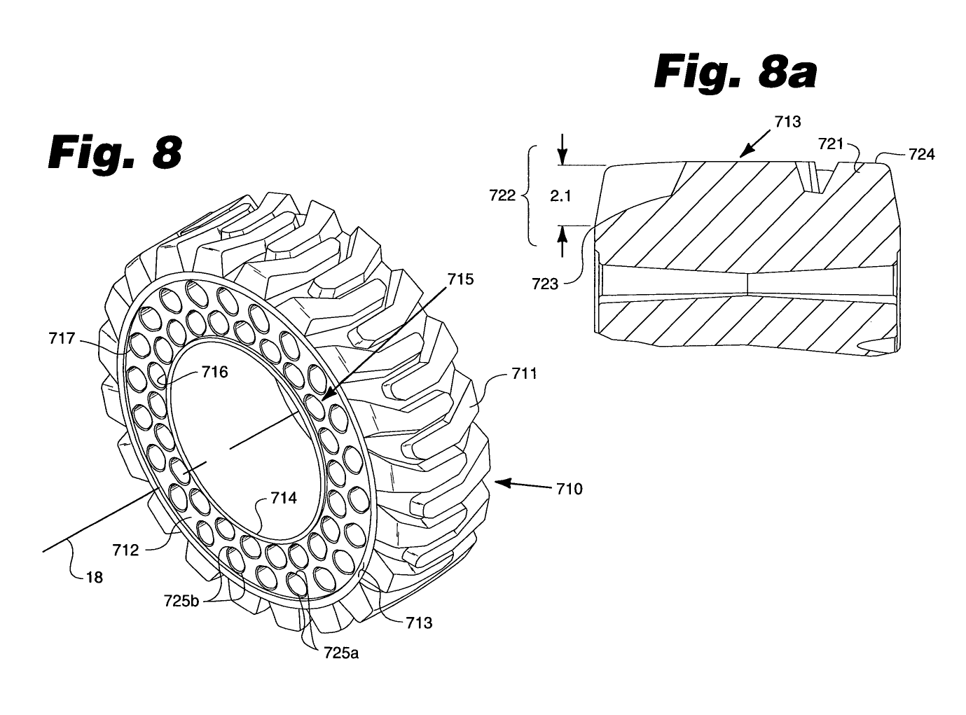

Referring to FIG. 8, there is shown an isometric view of a tire 710, according to an eighth embodiment of the present disclosure. The tire 710 includes an annular body 711 that includes a radial middle region 712 adjacent to a preferably cavity-free radial inner region 714 and a preferably cavity-free radial outer region 713. The material volume of the radial middle region 712 is 1.51 times (which is still about 1.5 times) greater than the combined void volume of the plurality of unpressurized cavities 715. The tire 710 includes forty-four unpressurized cavities 715, with twenty-two unpressurized cavities within each of the first and second radial bands 716 and 717. The tire 710 of the eighth embodiment is similar to the tire 610 of the seventh embodiment except that the diameter of the tire is thirty-three inches as compared to thirty-one inches and there are less cavities. In the illustrated eighth embodiment, each cavity within the plurality of cavities 715 includes a length of 2.0 inches, a width of 1.6 inches, and a depth of 5.4 inches for halfway through (10.8 inches if full width of tire).

Referring to FIG. 8a, there is shown a cross-sectioned view of a radial outer region 713 of the tire 710 of FIG. 8. Similar to the seventh embodiment, the radial outer region 713 includes an exposed off-road tread pattern 721 that has a depth 722 defined as the distance between a base 723 of the tread 721 and a top 724 of the tread 721. The depth 722 of the off-road tread pattern 721 of the eighth embodiment is 2.1 inches. Since the material void volume ratio is about the same as the seventh embodiment, the tire 710 may have a similar deflection even though the number of cavities 715 is less.

Referring to Table I, there is shown data summarizing the geometry for the eight embodiments of the tire 10,110, 210, 310, 410, 510, 610 and 710. Each tire 10, 110, 210, 310, 410, 510, and 610 is a 31 inch diameter tire whereas tire 710 is a 33 inch diameter tire.

TABLE I

| | TREAD DEPTH | STIFFNESS w/out tread | CAVITY WIDTH | CAVITY LENGTH | #HOLES/ | MAT'L/VOID |
|---|---|---|---|---|---|---|
| EMBOD. | in. | @4500#, lbs/inch | in. | in. | ROW | RATIO |
| 1 | 1.74 | 4800 | 0.9 | 2.3 | 20 | 2.0 |
| 2 | 1.98 | 5500 | 0.9 | 2.2 | 20 | 2.1 |
| 3 | 1.54 | 4400 | 1.1 | 2.3 | 20 | 1.8 |
| 4 | N/A | 4300 | 0.9 | 2.8 | 18 | 2.6 |
| 5 | N/A | N/A | 0.9 | 2.8 | 24 | 2.1 |
| 6 | 1.37 | 4100 | 1.1 | 2.6 | 20 | 1.6 |
| 7 | 1.74 | 9100 | 1.3 | 1.7 | 25 | 1.47 |
| 8 | 2.1 | 8400 | 1.6 | 2.0 | 22 | 1.51 |

However, in order to provide a desired stiffness and rubber strain, while also being able to support sufficient tread depth, the number, location and size of the cavities varies among the illustrated embodiments. Whereas, the tire 410 of the fifth embodiment may require the thinnest tread, it may have the stiffness closest to that of a pneumatic tire. For embodiments 1, 2, 3 and 6 that all have twenty cavities per row, increasing the material volume to combined void volume ratios increases the radial stiffness and also enables that design to carry a greater tread depth. Decreasing the number of apertures to eighteen cavities per row, such as shown in the fourth embodiment, or increasing the number of cavities to twenty-four cavities per row, such as in the fifth embodiment, changes the material to void ratio, stiffness of the tire, elastomer strain, and possible tread depth. These embodiments have larger material to void ratios, but their longer cavities, radial placement, and angular orientations combine to provide less radial stiffness. The shorter and wider cavities of the seventh and eighth embodiments may increase the overall stiffness and life of the tire. Though, it should be noted that these embodiments may not be optimized for maximum tread lug depth. Although the seventh and eighth embodiments are shown to have material to material void volumes ratios of 1.5, it is also contemplated that the apertures may be adjusted such that the ratio is much more or much less than a ratio of about 1.5.

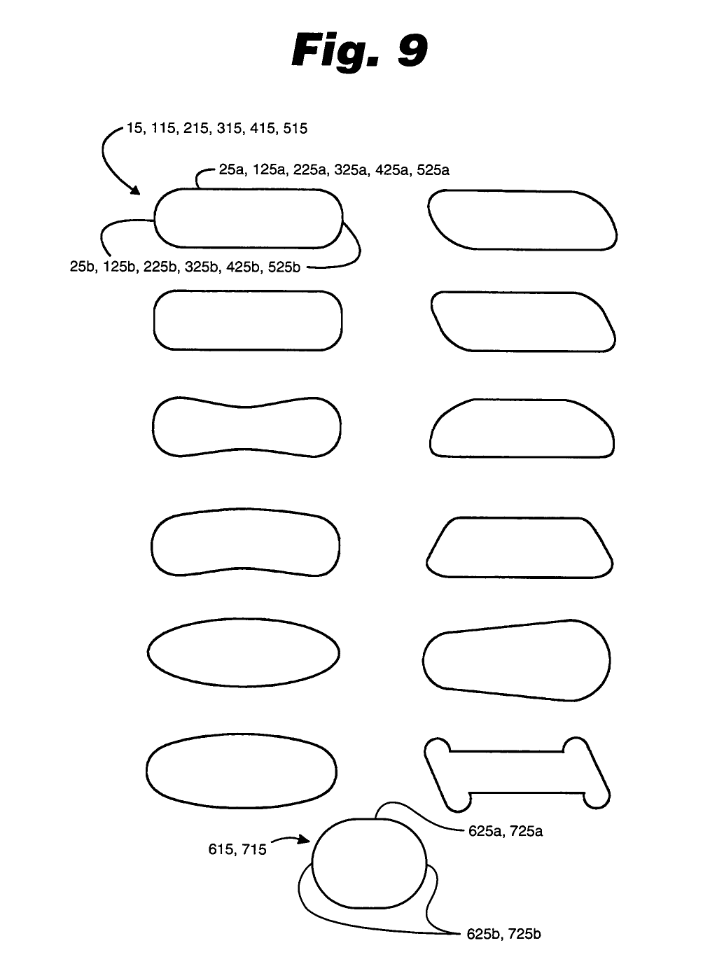

Referring to FIG. 9, there is shown a collection of diagrammatic representations of various-shaped cavities of tires, according to the present disclosure. The tires 10, 110, 210,310, 410, 510, 610 and 710 of the illustrated embodiments include pluralities of cavities 15, 115, 215, 315,415, 515, 615 and 715 that include a cross-sectional shape having the pair of straight deflectable wall portions 25a, 125a, 225a, 325a, 425a, 625a, 725a separated by the pair of symmetrical arches 25b, 125b, 225b, 325b, 425b, 625b, 725b. However, the present disclosure contemplates use of various other cavity shapes, all of which include a pair of deflectable wall portions separated by a pair of arches, including, but not limited to, those illustrated in FIG. 9. The shapes are preferably symmetrical, but can have a skewed shape. Further, the present disclosure contemplates a tire including non-uniform cavities. Those skilled in the art appreciate that there are various combinations of cavity shapes that can provide the desired stiffness, torque cancellation, and durability of the tire. Thus, FIG. 9 represents only a fraction of cavity shapes that are appropriate for the tire.

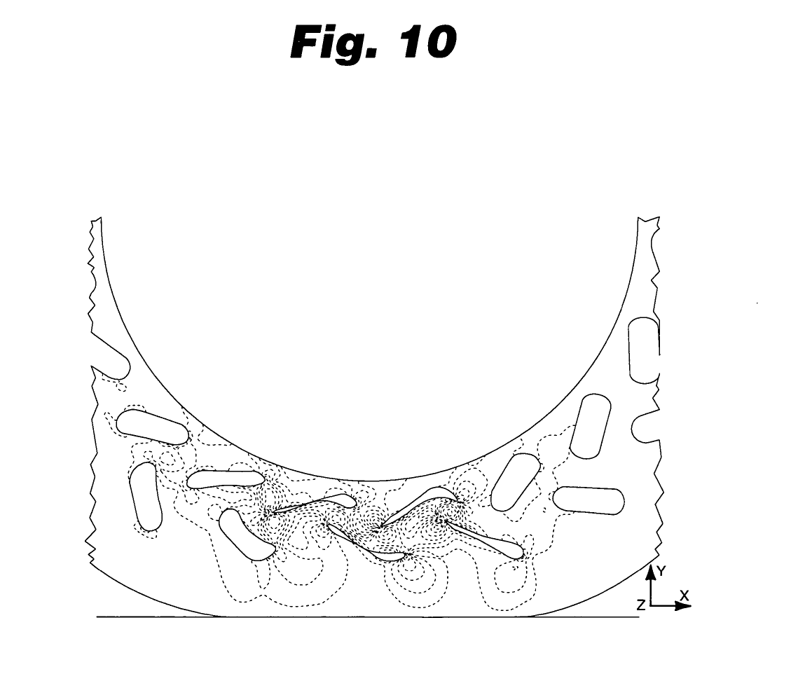

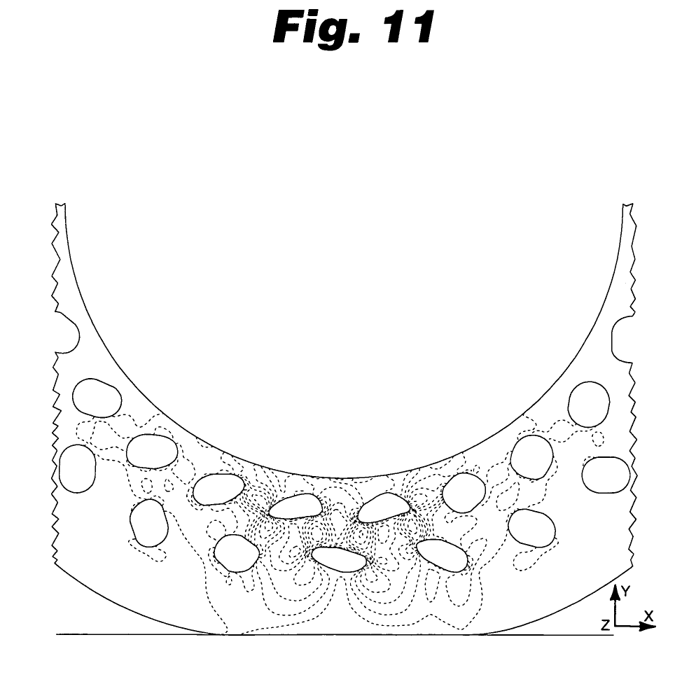

Referring to FIGS. 10 and 11, there are shown diagrammatic representations illustrating the deflection of a tire under a radial load. The dotted and dashed lines show contours of constant strain in the elastomeric material out of which the tire is manufactured. As can be seen, strain appears to the largest in small regions adjacent the arches of the respective cavities. The material surrounding the cavities absorbs the radial load primarily by bending the deflectable wall portions of each cavity toward one another while the arches at the opposite ends of each cavity deform to accommodate the deflection of the wall portions. This contrasts with other solid tires that carry a load via pure compression or stretching of the tire material. Thus, the tire deflects while minimizing material strain. The tire can include a progressive spring, or deflection, rate, meaning that stiffness is greater at higher radial loads than at lower radial loads. This assists the tire in supporting a load without collapsing the cavities at relatively high radial loads. However, when the tire is overloaded, the cavities can collapse such that the wall portions contact one another, and the radial load will be absorbed through the rubber-to-rubber contact in order to place an upper limit on the maximum strain for a given tire strain. For instance, for the tire 10 of the first embodiment, the overload protection collapse of the cavities 15 occurs at approximately 6,000 pounds as shown in FIG. 10. However, for the tire 610 of the seventh embodiment, the collapse of the cavities is not nearly as severe as at 6,000 pounds as shown in FIG. 11. Preferably, the cavities do not collapse over an expected nominal working load range for the particular tire, machine and application.

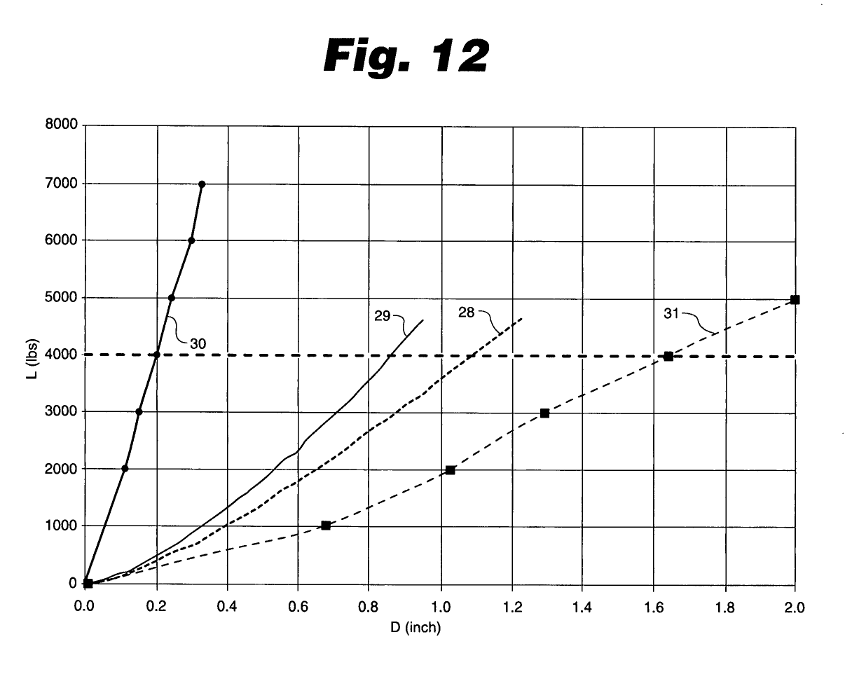

Referring to FIG. 12, there is shown a graph illustrating deflection (D) of a tire versus radial load (L), according to the present disclosure. Deflection (D) is illustrated along the x-axis in inches, and the radial load (L) is illustrated along the y-axis in pounds. The upward concavity of the curve demonstrates a progressive spring rate. The tire 10 of the first embodiment includes an average deflection rate 28 in this skid steer example of about 0.3 inches per 1000 pounds, at least up to a load of 4500 pounds. The tire 610 of the seventh embodiment includes an average deflection rate 29 of about 0.2 inches per 1000 pounds, at least up to a load of 4500 pounds. It is also contemplated that the deflection rates 28,29 may be extrapolated up to 4500 pounds and well beyond depending on the configuration. A deflection rate 30 of a conventional solid, non-pneumatic tire is about 0.05 inches per 1000 pounds. Although the deflection rate 31 of a conventional pneumatic tire is greater than the deflection rates 28 and 29 for the tires 10, 610, the deflection rates 28 and 29 for the tires 10,610 is more similar to the deflection rate 31 for the pneumatic tire than the deflection rate 30 of the solid tire.

### INDUSTRIAL APPLICABILITY

Referring to FIGS. 1-12 and Table I, the operation of the present disclosure will be discussed for the tire 10 illustrated in the first embodiment. However, those skilled in the art will appreciate that the operation of the present disclosure is similar for each tire 10, 110, 210, 310, 410, 510, 610 and 710 illustrated in each embodiment. Further, although the operation of the present disclosure will be discussed for a 31-inch diameter tire 10 for use with a skid steer loader, those skilled in the art should appreciate that the operation of the present disclosure is similar for various sized tires for use with various machines. Although the actual number, volume, shape and angle of the unpressurized cavities may vary among different sized tires for different machine applications, in every illustrated version of the present disclosure, the material volume is at least approximately one and a half times greater than the combined void volume, and the first radial band of cavities 16, 116, 216, 316, 416, 516, 616 and 716 is oriented at a positive angle with respect to a radius therethrough and the second radial band of cavities 17, 117, 217, 317, 417, 517, 617 and 717 is oriented at a negative angle with respect to a radius therethrough.

During normal operation of the skid steer loader, the tire 10 will be subjected to a predictable range of radial loads. Under this range of radial loads, the material around the plurality of cavities 15 absorbs the radial load primarily by bending rather than by pure compression or stretching, thereby maintaining a relatively low maximum strain on the material. The deflection of the tire 10 by bending the material that defines cavities 15 will cause a larger contact area with the ground, which provides increased traction. Due to the bending around the cavities 15 during normal operation of the machine, the tire 10 will have a stiffness more comparable to that of a pneumatic tire than a solid tire, and thus, provide the machine operator with a relatively smooth ride. As illustrated in FIG. 12, the deflection rate 28 of the tire 10 under 4000 pounds is more similar to the deflection rate 31 of a conventional pneumatic tire than the deflection rate 30 of a conventional solid tire.

However, during operation of the skid steer loader, the greater the radial load, the greater the material strain. Although the tire 10 may include the deflection rate of 0.3 inches per 1000 pounds up to 4000 pounds, the tire 10 includes a progressive spring rate that provides protection for the tire 10 and the skid steer loader. Thus, the tire 10 may become stiffer at higher radial loads. Because the tire 10 is stiffer at higher radial loads, the cavities 15 can remain open under the higher radial loads. However, at a point of overload, illustrated in the first embodiment as 6000 pounds, the cavities 15 will collapse, and the rubber-to-rubber contact will absorb the overload. The collapse will limit the strain that can be placed on the material.

During operation of the skid steer loader, there are certain situations, such as stopping the forward movement of the skid steer loader, that may create tangential forces on the tire 10. These tangential forces could also occur in a typical work cycle due to traction forces from digging, pushing, pulling, etc. The material surrounding the cavities 15 oriented at opposing angles can bend to absorb the tangential force. Although each radial band of cavities 16 and 17 will have a torsional stiffness bias in the direction of their respective angles, the second radial band of cavities 17 at the negative angle can cancel the torsional stiffness bias of the first radial band of cavities 16 at the positive angle, and vice versa. Thus, the torque will not move an outer portion of the tire 10 in relation to an inner portion of the tire 10 different amounts depending on whether the tangential force from the torque is in a forward direction or a reverse direction. The opposing angles of the cavities 15 provide a balanced clockwise and counterclockwise torsional stiffness for the tire.

In order to achieve a desired ride while maintaining durability under radial loads and a maximum tread depth of a tire, the geometry and material volume to combined void volume can be altered. In choosing the first embodiment other considerations were made, including an assessment of how similar the ride would be compared to a pneumatic tire, whether there was adequate lateral stability (i.e. no worse than a pneumatic tire), and whether the flotation and traction approximated a pneumatic tire. Other considerations included maximizing torsional stiffness, minimizing elastomer strain and finally, maximizing the radial load at which the cavities would collapse.

As shown in Table I, the material volume to combined void volume can be altered by altering the size, angle and number of the cavities. For instance, the tires 10, 110, 210 of the first, second and third embodiments have different material volume to combined void volume ratios because the size, rather than the number, of the cavities 15, 115, 215 differs among the tires 10, 110 and 210. Although a relatively low stiffness is desirable, the decrease in stiffness and strain is limited by the normal operating radial loads and the desired tread depth. The greater the normal operating load, the greater material volume to combined void volume may be required. The decrease in stiffness is also limited by the desired depth of the tread. Although maximum depth of tread is desired for traction and wear, the deeper the tread, the greater the radial area between the outer band of cavities and the outer diameter of the tire is required. Thus, in order for the tire to include a relatively deep tread, the cavities might need to be either reduced in size or made more compact to one another. In the first embodiment, the depth 22 of the tread 21 is 1.74 inches. Overall, it is generally a goal to maximize tread depth while maintaining a relatively low stiffness and material strain for off-road tires.

Further, those skilled in the art will appreciate that the present disclosure contemplates various methods for limiting the torsional stiffness bias through the opposing radial bands of cavities. In the first embodiment, the radial bands of cavities 16 and 17 are at different opposing angles, 63° positive angle and 52° negative angle with respect to a radial line through the center of the cavity, but each cavity within the plurality 15 has a uniform shape and size, which may include a taper. Each cavity 15 has straight segments or deflectable wall portions 15a separated by curved segments or arches 15b that have a width of approximately 0.9 inch. The total cavity length is about 2.3 inches. However, the present disclosure contemplates the torsional stiffness bias being cancelled by altering the angles, size, number and shape of the cavities 15. For instance, the torsional stiffness bias could also be cancelled by radial bands having the same positive and negative angles, but different sizes and/or shapes. There are various patterns that will provide a balanced clockwise and counterclockwise torsional stiffness for the tire. Reducing torsional stiffness bias can prevent or reduce uncontrolled forward/reverse motion of the machine during a change of a vertical load. In addition this same factor can serve to prevent or reduce uncontrolled vertical motion from a forward or reverse torque. There is also a desire to provide equal displacements in response to forward and reverse torques. Finally, there is a desire to balance strain in the material around the cavities during forward/reverse drive torque applications.

The present disclosure is advantageous because it provides a durable tire that provides a relatively smooth ride for a machine operator, the machine and the load. Because the material volume of the radial middle region 12 is, at least, approximately one and a half times greater than the combined void volume of the plurality of cavities 15, the tire can provide the durability required of a tire in harsh environments and under relatively substantial loads. However, because the tire 10 defines the plurality of cavities 15, the rubber can mostly bend, rather than purely compress or stretch, under the loads. Thus, the tire 10 can also provide more deflection, creating a softer ride, at lower rubber strains. Moreover, the radial bands of cavities 16 and 17 being oriented at positive and negative angles relative to a respective radius therethrough can cancel the torsional stiffness bias of one another. Thus, the material surrounding the cavities 15 can absorb the tangential forces acting on the tire 10 while limiting the rotation of the outer portion of the tire relative to the inner portion during periods of acceleration, deceleration, and torques due to normal work cycles.

The present disclosure is also advantageous because the tire 10 and machine is protected from overload. Because the tire 10 include the progressive deflection rate, the increased stiffness at higher radial loads allows the cavities 15 to remain open at the higher radial loads. However, when the tire is subjected to an overload situation, the tire 10 will limit the material strain by collapsing the cavities 15. The rubber-to-rubber contact can absorb the overload but the tire then performs more like a solid tire.

Moreover, the present disclosure is advantageous because the dimensions of the radial middle region can be adjusted to fit the desired operating goals of each specific tire. The compromise between tread depth and strain and stiffness can be adjusted by adjusting the material volume to combined void volume ratio. Further, the angles, size, number and shapes of the cavities can be adjusted in order to sufficiently cancel the torsional stiffness bias of the radial band of cavities and produce other known performance characteristics.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A tire, comprising:
an annular body of elastomeric material that includes a radial middle region having a material volume and defining a plurality of unpressurized cavities with a combined void volume, the plurality of unpressurized cavities being distributed in a pattern that includes a first radial band of cavities and a second radial band of cavities;
each cavity of said first radial band of cavities being oriented at a positive angle with respect to a radius line extending from a tire axis of rotation through the respective cavity;
each cavity of said second radial band of cavities being oriented at a negative angle with respect to a radius line extending from a tire axis of rotation through the respective cavity; and
said material volume being about 1.4 times greater than said combined void volume.

2. The tire of claim 1 wherein the material volume is within a range of about 1.4 to about 1.6 times greater than said combined void volume.

3. The tire of claim 1 wherein the material volume is about one and a half times greater than said combined void volume.

4. The tire of claim 1 having an average deflection rate that is within a range of about 0.2 inches to about 0.3 inches per 1000 pounds at least up to a load of 4500 pounds.

5. The tire of claim 4 wherein the average deflection rate is about 0.2 inches 1000 pounds at least up to a load of 4500 pounds

6. The tire of claim 2 wherein each of said radial bands has twenty-five cavities.

7. The tire of claim 6, wherein the diameter of said tire is thirty-one inches.

8. The tire of claim 2, wherein each of said radial bands has twenty-two cavities.

9. The tire of claim 8, wherein the diameter of said tire is thirty-three inches.

10. The tire of claim 1 wherein a total number of unpressurized cavities is at least forty.

11. The tire of claim 1 wherein said unpressurized cavities each have a cross-sectional shape with a perimeter that includes a pair of straight segments separated by a pair of curved segments.

12. The tire of claim 1 including at least one barrier separating said unpressurized cavities from space surrounding the tire.

13. The tire of claim 1 including at least one sleeve that extends at least a part of the way through the width of said unpressurized cavity.

14. The tire of claim 1 wherein said first radial band of cavities includes an inboard band of cavities and an outboard band of cavities that are out of phase with respect to said inboard band of cavities about a tire axis of rotation.

15. The tire of claim 1 wherein said unpressurized cavities extend a majority of a width of said radial middle region.

16. The tire of claim 1 wherein said annular body includes a cavity-free radial outer region adjacent said middle region that includes an exposed off-road tread pattern.

17. The tire of claim 1 wherein a length of each of the plurality of unpressurized cavities is less than approximately one and a half times a width of each of the plurality of unpressurized cavities.

18. A tire comprising:
an annular body of elastomeric material that includes a radial middle region defining a plurality of unpressurized cavities that are distributed in a pattern that includes a first radial band of cavities and a second radial band of cavities;
each cavity of the first radial band of cavities being oriented at a positive angle with respect to a radius line extending from a tire axis of rotation through the respective cavity;
each cavity of the second radial band of cavities being oriented at a negative angle with respect to a radius line extending from a tire axis of rotation through the respective cavity;
each of said plurality of cavities being defined by first and second arches connected by first and second deflectable wall portions; and
said radial middle region having a material volume being about 1.4 times greater than said combined void volume of the plurality of unpressurized cavities.

19. The tire of claim 18 wherein said plurality of cavities are sized and arranged such that a radial load causes said first and second wall portions to deflect towards one another in an area adjacent said radial load.

20. A tire, comprising:
an annular body of elastomeric material that includes a radial middle region having a material volume and defining a plurality of unpressurized cavities with a combined void volume, the plurality of unpressurized cavities being distributed in a pattern that includes a first radial band of cavities and a second radial band of cavities;
each cavity of said first radial band of cavities being oriented at a positive angle with respect to a radius line extending from a tire axis of rotation through the respective cavity;
each cavity of said second radial band of cavities being oriented at a negative angle with respect to a radius line extending from a tire axis of rotation through the respective cavity; and
wherein a length of each of the plurality of unpressurized cavities is less than approximately one and a half times a width of each of the plurality of unpressurized cavities.
